(19) United States
(12) Patent Application Publication
(10) Pub. No.: US 2023/0257171 A1
(43) Pub. Date: Aug. 17, 2023

(54) FUNNEL FOR LONG TERM ATTACHMENT TO A FLUID RESERVOIR

(71) Applicant: Arlett Tygesen, Toronto (CA)

(72) Inventor: Arlett Tygesen, Toronto (CA)

(21) Appl. No.: 18/167,457

(22) Filed: Feb. 10, 2023

Related U.S. Application Data
(60) Provisional application No. 63/310,255, filed on Feb. 15, 2022.

(51) Int. Cl. B65D 51/24; B65D 41/18; B65D 21/08; B65D 25/44; B67C 11/02

(52) U.S. Cl. CPC B65D 51/24; B65D 41/18; B65D 21/086; B65D 25/44; B67C 11/02

(57) ABSTRACT

A funnel system for attachment to a fluid reservoir. The funnel is telescopically expandable and include an adaptor that provides for attachment to a variety of different fluid reservoir openings. A snap cap is also provided that seals the fluid path when the fluid is not in use. In one embodiment, the funnel system is attached to the fluid reservoir for a prolonged period of time and functions to replace the stock cap on the reservoir.

### CROSS-REFERENCE TO RELATED APPLICATIONS

This application claims priority to, and is a non-provisional of U.S. Patent Application Ser. No. 63/310,255 (filed Feb. 15, 2022), the entirety of which is incorporated herein by reference.

### BACKGROUND OF THE INVENTION

Conventionally, when windshield washer fluid is added to an automobile, spillage is a problem. Traditional methods of pouring windshield washer fluid into the windshield washer reservoir suffer in that the pouring hole is typically only 3.8-5 cm (1.5-2 inches) wide. When trying to pour liquid from a heavy container of windshield washer fluid (a 4 liter/1 gallon container of windshield washer fluid weighs over 3.6 kg/8 lbs) from a typical pouring height of 12.7-25.4 cm (5-10 inches), the need for precision pouring is considerable or spillage is inevitable. Most people tend to spill a little (or a lot) of windshield fluid in the engine and transmission areas and on the ground trying to maneuver heavy and unwieldy fluid container. This is wasteful, costly, environmentally unfriendly to the earth, pets and other small animals and even potentially toxic to humans such as young children if the fluid pools on the driveway or road and a child ingests it. An improved system is therefore desired.

The discussion above is merely provided for general background information and is not intended to be used as an aid in determining the scope of the claimed subject matter.

### SUMMARY

This disclosure provides a funnel system for attachment to a fluid reservoir. The funnel is telescopically expandable and, in some embodiments, includes an adaptor that provides for attachment to a variety of different fluid reservoir openings. A snap cap is also provided that seals the fluid path when the fluid is not in use. In one embodiment, the funnel system is attached to the fluid reservoir for a prolonged period of time and functions to replace the stock cap on the reservoir.

In a first embodiment, a funnel system is provided. The funnel system comprising: a funnel comprising: a rigid upper rim edge defining an upper opening; a rigid lower rim edge connected to the rigid upper rim edge by alternating circular supports and flexible supports such that the funnel expands and contracts by telescopically expanding the alternating circular supports and flexible supports; wherein the rigid lower rim edge defines a lower opening with threads, the upper opening having a larger diameter than the lower opening; and a snap cap attached to the funnel.

In a second embodiment, a funnel system is provided. The funnel system comprising: a funnel comprising: a rigid upper rim edge defining an upper opening; a rigid lower rim edge connected to the rigid upper rim edge by alternating circular supports and flexible supports such that the funnel expands and contracts by telescopically expanding the alternating circular supports and flexible supports; wherein the rigid lower rim edge defines a lower opening with threads, the upper opening having a larger diameter than the lower opening; and a snap cap attached to the funnel; an adaptor comprising: a top disc with a threaded outer circumference configured to engage the threads of the rigid lower rim edge; a bottom disc with a threaded outer circumference configured to engage threads on a fluid reservoir; and a fluid path that extends through the adaptor such that fluids may be poured through the funnel, through the adaptor and into the fluid reservoir.

In a third embodiment, a fluid reservoir system is provided. The fluid reservoir system comprising: a fluid reservoir; a funnel comprising: a rigid upper rim edge defining an upper opening; a rigid lower rim edge connected to the rigid upper rim edge by alternating circular supports and flexible supports such that the funnel expands and contracts by telescopically expanding the alternating circular supports and flexible supports; wherein the rigid lower rim edge defines a lower opening with threads, the upper opening having a larger diameter than the lower opening; and a snap cap attached to the funnel; an adaptor comprising: a top disc with a threaded outer circumference configured to engage the threads of the rigid lower rim edge; a bottom disc with a threaded outer circumference configured to engage threads on the fluid reservoir; and a fluid path that extends through the adaptor such that fluids may be poured through the funnel, through the adaptor and into the fluid reservoir.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a sideview of one embodiment of a funnel with a snap cap and an adaptor, wherein the funnel is in an expanded state;

FIG. 2A is a cross section view of the adaptor with the snap cap in an unconnected state;

FIG. 2B is a cross section view of the adaptor with the snap cap in a connected state (left) and a top perspective view of the snap cap (right);

FIG. 3 is a top perspective view of the funnel with the snap cap and the adaptor in an unconnected state; and

FIG. 4 shows a top perspective view (upper pane) and bottom perspective view (lower pane) of another embodiment of the funnel.

### DETAILED DESCRIPTION OF THE INVENTION

This disclosure provides a collapsible BPA-free polycarbonate plastic funnel that attaches to the windshield washer fluid reservoir. The funnel is designed to ensure accuracy of pouring and to avoid spillage of chemical contaminants. It is designed for the after-market automotive space yet has wide-ranging application possibilities in multiple other industries. The funnel is configured to permit permanent attachment to a vehicle. The user expands the funnel to add fluid to the fluid reservoir and then collapses the funnel when not in use while leaving the funnel attached to the reservoir.

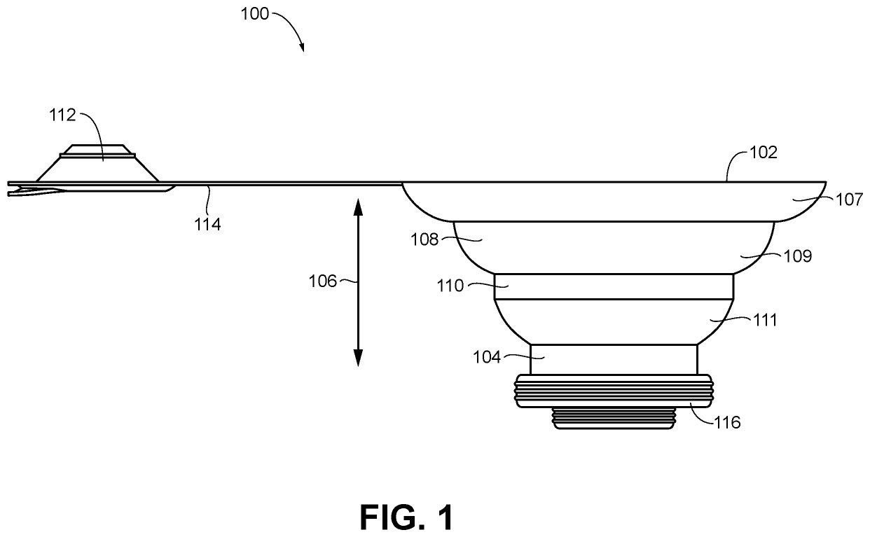

Referring to FIG. 1, the funnel 100 has a rigid upper rim edge 102 and a rigid lower rim edge 104 to ensure stability of the funnel 100 when attached to a reservoir. The rigid upper rim edge 102 defines an upper opening and the rigid lower rim edge 104 defines a lower opening. In one embodiment, both the rigid upper rim edge 102 and the rigid lower rim edge 104 are circular. The funnel 100 telescopes in the direction of arrow 106 to expand from a height of approximately 1.27 cm (0.5 inch) to a height of approximately 7.6-10.2 cm (3-4 inches). A series circular supports 108, 110 are provided which have different diameters. In the embodiment of FIG. 1, two circular supports 108, 110 are present wherein the circular support 108 has a diameter greater than the diameter of the circular support 110. Each circular support is directly attached to at least one adjacent circular support with a flexible support formed from, for example, a flexible rubber. The circular supports and the flexible supports alternate to allow telescopic expansion of the funnel 100. In the embodiment of FIG. 0.1, the top-most circular support (e.g. circular support 108) is connected to an adjacent circular support (e.g. circulator support 110) with a flexible support (e.g. flexible support 109) and is also connected to the rigid upper rim edge 102 with a flexible support 107. The bottom-most circular support (e.g. circular support 110) is connected to an adjacent circular support (e.g. circular support 108) with the flexible support (e.g. flexible support 109) and is also connected to the rigid lower rim edge 104 with a flexible support 111. In those embodiments, where three or more circular supports are present, each non-terminal circular support is attached to two adjacent circular supports with respective flexible supports.

In one embodiment, the circular supports and flexible supports are concentric such that they share the same center. In one such embodiment, the concentric circular supports are also concentric with regard to the rigid upper rim edge 102 and the rigid lower rim edge 104. The circular support with the largest diameter (e.g. circular support 108) is proximate to the rigid upper rim edge 102. The circular support with the smallest diameter (e.g. circular support 110) is proximate to the rigid lower rim edge 104. The series of concentric circular supports decrease in diameter from the rigid upper rim edge 102 to the rigid lower rim edge 104.

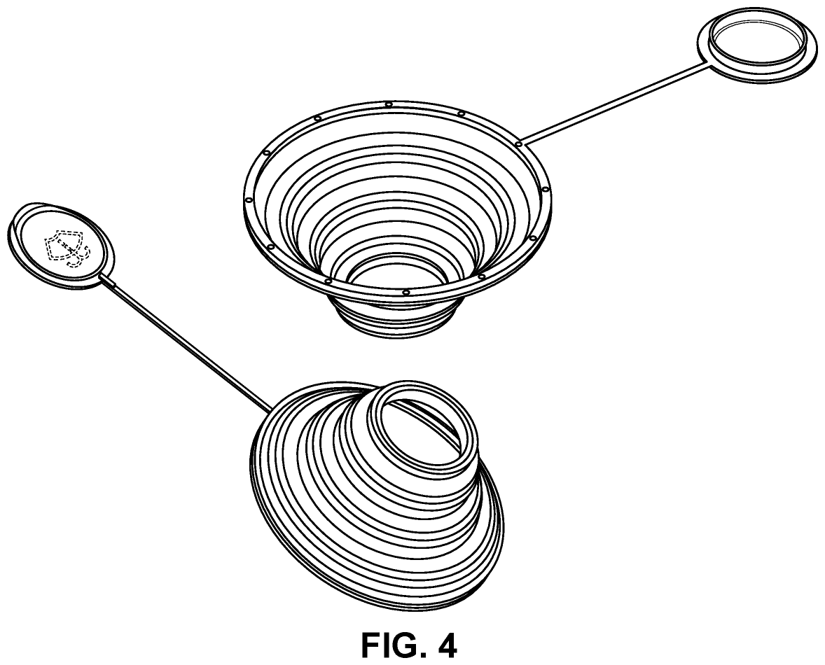

A snap cap 112 is connected to the funnel 100 with a flexible arm 114 to securely close the funnel opening when collapsed so that debris cannot enter the reservoir and so that liquid cannot escape the reservoir. In one embodiment, the snap cap 112 is monolithic with the funnel 100. For example, the entire funnel 100, including the snap cap 112 may be one-piece. In one such embodiment, the funnel 100 is formed of a silicon polymer. In another embodiment, the snap cap 112 is removably connected to the funnel (see, for example, FIG. 4).

In the embodiment of FIG. 1, an adaptor 116 is removably attached to the funnel 100 at the rigid lower rim edge 104. The rigid lower rim edge 104 defines a lower opening with threads (e.g. such as internal threads, not shown in FIG. 1) configured to attach to the adaptor 116.

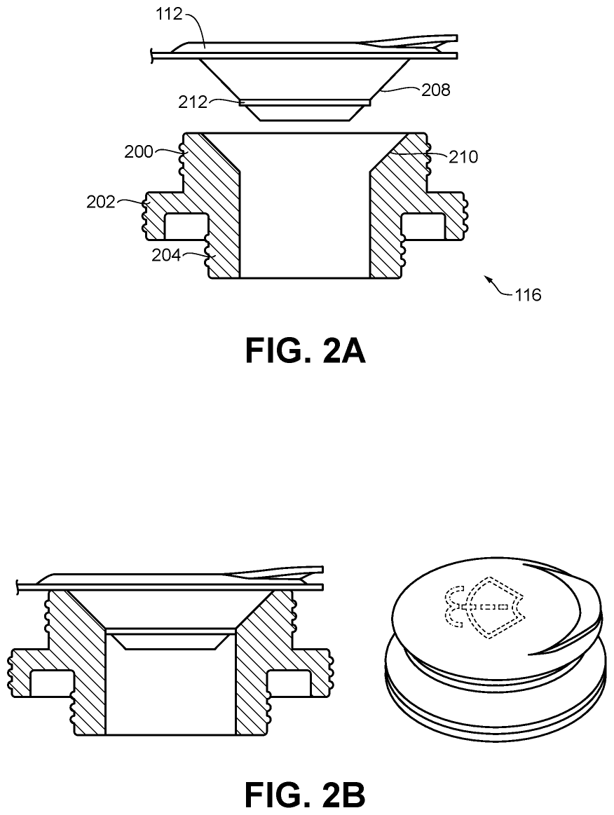

Referring to FIG. 2A and the embodiment depicted therein, the snap cap 112 is shown with the remainder of the funnel 100 being omitted for clarity of illustration. A cross section of the adaptor 116 is shown. In the embodiment of FIG. 2A, the adaptor 116 is monolithic and has three discs including a top disc 200, a central disc 202, a bottom disc 204. A fluid path extends through each of the discs to permit fluid to flow from the funnel 100, through the adaptor 116 and into the reservoir. Each of the discs have a threaded outer circumference and a diameter that is different than the diameter of the other discs. The threaded top disc 200 is configured to attach to the rigid lower rim edge 104 and engage corresponding internal threads therein. By providing threaded discs with different diameters the adaptor 116 can fit several different models of fluid reservoirs even if the reservoirs have different mouths. For example, in the embodiment of FIG. 2A, the central disc 202 has a diameter that is greater than the diameter of the bottom disc 204. When connecting with a fluid reservoir with a large opening, the central disc 202 may be directly connected to the fluid reservoir opening and the bottom disc 204 remains inserted with the opening without engaging the threads of the opening. Additionally, because the adaptor 116 is removably attached to the funnel 100, several adaptors 116 can be provided that have discs with different diameters, thereby providing even more options for attaching the funnel 100 to different reservoirs. Depending on the specific size of a reservoir (which is based on vehicle make or model) the user will choose from different adaptors 116, accommodating a range for each size.

The snap cap 112 has a male conical section 208 that securely mates with a corresponding female conical section 210 of the adaptor 116. In this manner, the snap cap 112 can be securely attached to the adaptor 116. In another embodiment, the female conical section is present in the rigid lower rim edge 104, rather than in the adaptor 116. A protruding ring 212 provides a snap connection to hold the snap cap 112 in place. FIG. 2B illustrates the snap cap 212 after being secured to the adaptor 116. This snug fit avoids any vibrational loosening of the funnel 100 over time and secures attachment of the funnel 100 to the reservoir. The adaptor 116 and funnel 100 are designed to sit permanently on the reservoir but can be removed at any time without damage to the funnel 100 or the reservoir. In one embodiment, the funnel 100 remains attached to the reservoir for at least one week. The funnel 100 can be used for cars, trucks, transport trucks, ATVs, lawnmowers, boats, plastic gas cans and other devices where an extended pouring diameter could be beneficial. In one embodiment, the rigid lower rim edge 104 has threads that directly engages with threads on the fluid reservoir, thus obviating the adaptor 116. In such an embodiment, the lower rim edge 104 is customized to mate with a particular fluid reservoir to form a liquid-tight seal and is particularly useful when the funnel 100 is connected at the point of manufacture (e.g. directly to the fluid reservoir of a particular make and model of vehicle at its point of manufacture).

In use, the stock cap on the fluid reservoir (e.g. windshield wiper fluid reservoir) is permanently replaced with the adaptor 116 and the funnel 100 is then permanently attached to the adaptor 116. The funnel is collapsed and the snap cap 112 is used to close the fluid reservoir. When the user desires to add additional fluids, the snap cap 112 is removed and the funnel 100 is expanded. The fluid can then easily be added to the fluid reservoir using the funnel 100. After addition of the fluid, the funnel is then collapsed and the snap cap 112 is used to re-seal the fluid reservoir.

In one embodiment, the rigid upper rim edge 102 has a diameter of 12.7 cm (5 inches) which enables clean and non-spilling capabilities by providing a wide mouth. The wide mouth allows fluids to be completely captured. The telescoping funnel can eliminate spillage and waste. When not in use, it folds down on top of the reservoir, taking up no more space than approximately 1.3 cm (0.5 inch), sitting almost flush on the reservoir. The funnel 100 remains out of the way for the next use.

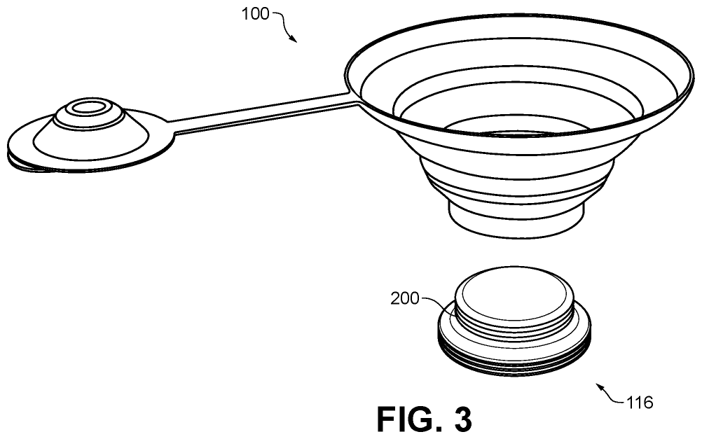

FIG. 3 depicts the funnel 100 and the adaptor 116 in a disconnected state.

FIG. 4 provide two alternate views of the funnel 100 in an expanded state, wherein the adaptor 116 is not present.

While the invention has been described with reference to certain embodiments, it will be understood by those skilled in the art that various changes may be made and equivalents may be substituted for elements thereof to adapt to particular situations without departing from the scope of the disclosure. Therefore, it is intended that the claims not be limited to the particular embodiments disclosed, but that the claims will include all embodiments falling within the scope and spirit of the appended claims.

What is claimed is:

1. A funnel system comprising:
a funnel comprising:
a rigid upper rim edge defining an upper opening;
a rigid lower rim edge connected to the rigid upper rim edge by alternating circular supports and flexible supports such that the funnel expands and contracts by telescopically expanding the alternating circular supports and flexible supports;
wherein the rigid lower rim edge defines a lower opening with threads, the upper opening having a larger diameter than the lower opening; and
a snap cap attached to the funnel.

2. A funnel system comprising:
a funnel comprising:
a rigid upper rim edge defining an upper opening;
a rigid lower rim edge connected to the rigid upper rim edge by alternating circular supports and flexible supports such that the funnel expands and contracts by telescopically expanding the alternating circular supports and flexible supports;
wherein the rigid lower rim edge defines a lower opening with threads, the upper opening having a larger diameter than the lower opening; and
a snap cap attached to the funnel;
an adaptor comprising:
a top disc with a threaded outer circumference configured to engage the threads of the rigid lower rim edge;
a bottom disc with a threaded outer circumference configured to engage threads on a fluid reservoir; and
a fluid path that extends through the adaptor such that fluids may be poured through the funnel, through the adaptor and into the fluid reservoir.

3. The funnel system as recited in claim 2, wherein the adaptor further comprises a central disc disposed between the top disc and the bottom disc, wherein the central disc comprises a threaded outer circumference and the central disc has a diameter that is different than a diameter of the bottom disc.

4. The funnel system as recited in claim 2, wherein the snap cap is attached to the funnel with a flexible arm.

5. The funnel system as recited in claim 4, wherein the snap cap, the funnel and the flexible arm are monolithic.

6. The funnel system as recited in claim 2, wherein the snap cap further comprises a male conical section.

7. The funnel system as recited in claim 6, wherein the adaptor comprises a female conical section configured to engage the male conical section of the snap cap.

8. The funnel system as recited in claim 7, wherein the snap cap further comprises a protruding ring that provides a snap-connection between the snap cap and the female conical section.

9. A fluid reservoir system comprising:
a fluid reservoir;
a funnel comprising:
a rigid upper rim edge defining an upper opening;
a rigid lower rim edge connected to the rigid upper rim edge by alternating circular supports and flexible supports such that the funnel expands and contracts by telescopically expanding the alternating circular supports and flexible supports;
wherein the rigid lower rim edge defines a lower opening with threads, the upper opening having a larger diameter than the lower opening; and
a snap cap attached to the funnel;
an adaptor comprising:
a top disc with a threaded outer circumference configured to engage the threads of the rigid lower rim edge;
a bottom disc with a threaded outer circumference configured to engage threads on the fluid reservoir; and
a fluid path that extends through the adaptor such that fluids may be poured through the funnel, through the adaptor and into the fluid reservoir.

10. The fluid reservoir system as recited in claim 9, wherein the bottom disc of the adaptor is directly connected to the fluid reservoir and the top disc is directly connected to the rigid lower rim edge of the funnel.

11. The fluid reservoir system as recited in claim 10, wherein the snap cap is mated with the fluid path such that the fluid path is closed.

12. The fluid reservoir system as recited in claim 11, wherein the bottom disc of the adaptor remains directly connected to the fluid reservoir for at least one week.

13. The fluid reservoir system as recited in claim 9, wherein the adaptor further comprises a central disc disposed between the top disc and the bottom disc, wherein the central disc comprises a threaded outer circumference and the central disc has a diameter that is different than a diameter of the bottom disc.

14. The fluid reservoir system as recited in claim 13, wherein the central disc of the adaptor is directly connected to the fluid reservoir and the top disc is directly connected to the rigid lower rim edge of the funnel.

15. The fluid reservoir system as recited in claim 9, wherein the snap cap further comprises a male conical section.

16. The fluid reservoir system as recited in claim 15, wherein the adaptor comprises a female conical section configured to engage the male conical section of the snap cap.
